(19) United States
(12) Patent Application Publication
(10) Pub. No.: US 2025/0165334 A1
(43) Pub. Date: May 22, 2025

(54) FUNCTIONAL SAFETY BIST WITH SYSTEM VITALS

(71) Applicant: Signature IP Corporation, Milpitas, CA (US)

(72) Inventors: Kishore Mishra, Santa Clara, CA (US); Parag Bhatt, San Jose, CA (US); Purna Mohanty, Sunnyvale, CA (US)

(73) Assignee: Signature IP Corporation, Milpitas, CA (US)

(21) Appl. No.: 18/953,162

(22) Filed: Nov. 20, 2024

Related U.S. Application Data
(60) Provisional application No. 63/688,925, filed on Aug. 30, 2024.
(60) Provisional application No. 63/663,205, filed on Jun. 24, 2024.
(60) Provisional application No. 63/643,941, filed on May 8, 2024.
(60) Provisional application No. 63/551,091, filed on Feb. 8, 2024.
(60) Provisional application No. 63/617,823, filed on Jan. 5, 2024.
(60) Provisional application No. 63/615,862, filed on Dec. 29, 2023.
(60) Provisional application No. 63/601,497, filed on Nov. 21, 2023.

(51) Int. Cl. G06F 11/07

(52) U.S. Cl. CPC G06F 11/079; G06F 11/0739

(57) ABSTRACT

Built-in self-test (BIST) execution is enabled in various applications, including embedded systems, such as those found in vehicles, medical equipment, avionics, and/or other systems of critical importance. An automotive subsystem within a motor vehicle is accessed. The automotive subsystem includes a system-on-a-chip (SoC). The SoC includes a network-on-a-chip (NoC). The SoC is coupled to a communications bus. The communications bus includes a bus controller. The SoC is coupled to a functional safety test environment (FUSATE). The FUSATE is awakened from a low power mode by a timer. The FUSATE a test sequence to one or more logic components within the SOC. The test sequence includes a functionality check of the one or more logic components. The FUSATE receives a first response from the one or more logic components within the SoC and records the first response. The FUSATE reenters the low power mode, resetting the timer.

### RELATED APPLICATIONS

This application claims the benefit of U.S. provisional patent applications “Functional Safety BIST With System Vitals” Ser. No. 63/601,497, filed Nov. 21, 2023, “Trace-Based Testing With Software Access Points” Ser. No. 63/615,862, filed Dec. 29, 2023, “Round Robin Bus Arbitration With Control Vectors and Increment And Decrement Functions”, Ser. No. 63/617,823, filed Jan. 5, 2024, “Weighted Round Robin Bus Arbitration With Control Vectors And Increment And Decrement Functions” Ser. No. 63/551,091, filed Feb. 8, 2024, “Coupling Network-On-Chip Sub-Topologies With Derivative Clocks” Ser. No. 63/643,941, filed May 8, 2024, “Cloud-Native Network-On-Chip Validation With Sub-Topologies” Ser. No. 63/663,205, filed Jun. 24, 2024, and “Cloud-Native Network-On-Chip Validation Including Sub-Topologies, Ser. No. 63/688,925, filed Aug. 30, 2024.

Each of the foregoing applications is hereby incorporated by reference in its entirety.

### FIELD OF ART

This application relates generally to electronics and more particularly to functional safety built-in self-test (BIST) with system vitals.

### BACKGROUND

Safety in manufactured products is of paramount importance for several reasons. Ensuring the safety of manufactured products is a fundamental way to protect consumers. Unsafe products can lead to injuries, health hazards, or even fatalities. Manufacturers have a responsibility to produce goods that do not harm the people who use them. Many countries have strict regulations and standards in place to govern the safety of products. Failure to meet these standards can result in legal consequences, including fines, product recalls, and damage to a company's reputation. On the positive side, a product that is known to be safe and reliable can enhance a company's reputation. Conversely, a product with a history of safety issues can tarnish a brand's image, resulting in loss of trust and customer loyalty. Moreover, ensuring product safety can help reduce a manufacturer's liability in the event of accidents or injuries caused by their products. If a product is proven to meet safety standards and guidelines, it can be easier for a manufacturer to defend against legal claims. Furthermore, investing in safety measures during the design and manufacturing phases can help prevent costly product recalls, lawsuits, and repairs. It is often more cost effective to build safety into a product from the start than to address safety issues after a product has been released to the market.

In addition to safety, general quality is also of paramount importance for manufactured products. High-quality products lead to satisfied customers. When products meet or exceed customer expectations, it fosters loyalty and positive word-of-mouth, which can attract new customers and retain existing ones. Consistently delivering high-quality products enhances a brand's reputation. Positive reviews, recommendations, and a strong brand image are all built upon a foundation of quality. Furthermore, catching and rectifying defects early in the development process is far less expensive than addressing them after the product is released. Effective testing helps identify issues before the products reach customers, reducing the costs associated with recalls, repairs, and customer support. Moreover, high-quality products give a competitive edge in the market. When customers have a choice between products, they are more likely to choose the one known for its quality and reliability.

Testing is a major component for achieving high quality in products. Quality assurance (QA) and quality control (QC) stages of product development serve to catch issues before products are deployed to end users. The QA/QC process involves systematically evaluating a product's functionality, performance, and usability to identify defects, inconsistencies, and areas for improvement. Testing helps identify defects, bugs, and inconsistencies in the product's design and functionality. Early detection allows teams to address these issues before the product reaches customers. Additionally, testing validates that the product meets its intended requirements and verifies that it functions as expected. Testing can be used to confirm that the product aligns with user needs and business goals. Moreover, testing assesses how well the product performs under various conditions, such as load, stress, and scalability. This helps ensure the product can handle real-world usage.

Thus, quality and safety are fundamental aspects of products and services that directly impact brand reputation, customer satisfaction, and business success. Prioritizing safety can protect consumers, enhance a company's reputation, reduce liabilities, and contribute to overall business success. Furthermore, safe and high-quality products give a competitive edge in the market. When customers have a choice between products, they are more likely to choose the one known for its quality and reliability.

### SUMMARY

The various electronic subsystems benefit from frequent and periodic testing. The testing can be in-situ testing. The testing can include Built-in Self-Test (BIST) test cases. Built-in Self-Tests (BIST) are self-contained testing mechanisms integrated into electronic products and systems. These tests offer several benefits in terms of product development, manufacturing, and ongoing maintenance. BIST can help identify faulty components or manufacturing defects early in the production process. By detecting issues before products leave the assembly line, manufacturers can reduce the number of defective units and associated warranty costs. BIST often provides detailed diagnostic information about the location and nature of faults within a product or system. This information can expedite the repair or replacement of faulty components, reducing downtime and maintenance costs. With disclosed embodiments, BIST can be designed to run periodic self-tests of system vitals during normal operation. This continuous monitoring can detect and alert users to potential issues before they lead to system failures, allowing for proactive maintenance and minimizing downtime. BIST can contribute to extending the operational lifespan of products and systems by enabling proactive maintenance and repair. This can be particularly valuable for automobiles, where replacement parts for automotive subsystems may be scarce and/or costly.

Built-in self-test (BIST) execution is enabled in various applications, including embedded systems, such as those found in vehicles, medical equipment, avionics, and/or other systems of critical importance. An automotive subsystem within a motor vehicle is accessed. The automotive subsystem includes a system-on-a-chip (SoC). The SoC includes a network-on-a-chip (NoC). The SoC is coupled to a communications bus. The communications bus includes a bus controller. The SoC is coupled to a functional safety test environment (FUSATE). The FUSATE is awakened from a low power mode by a timer. The FUSATE a test sequence to one or more logic components within the SOC. The test sequence includes a functionality check of the one or more logic components. The FUSATE receives a first response from the one or more logic components within the SoC and records the first response. The FUSATE reenters the low power mode, resetting the timer.

A processor-implemented method for testing is disclosed comprising: accessing an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE); awakening, by a timer, the FUSATE from a low power mode; sending, by the FUSATE, to one or more logic components within the SOC, a test sequence, wherein the test sequence includes a functionality check of the one or more logic components; receiving, by the FUSATE, a first response from the one or more logic components within the SoC; recording, by the FUSATE, the first response that was received; and reentering, by the FUSATE, the low power mode, wherein the reentering includes resetting the timer. In embodiments, the FUSATE is external to the SOC, wherein the FUSATE is coupled to the bus controller and the communications bus. Some embodiments comprise arbitrating, by the bus controller, between the test sequence and one or more functional transactions on the communications bus. In embodiments, the first response is interleaved, by the bus controller, with one or more functional transactions.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for functional safety BIST with system vitals.

FIG. 2 is a flow diagram for recording a response.

FIG. 3 is a block diagram for a functional safety test environment (FUSATE).

FIG. 4A is a first block diagram for functional safety BIST with system vitals.

FIG. 4B is a second block diagram for functional safety BIST with system vitals.

FIG. 5 is an example of an automotive functional test system.

FIG. 6 is a block diagram for sending functional safety information.

FIG. 7 is an example of accessing responses on a server.

FIG. 8 is a system diagram for functional safety BIST with system vitals.

### DETAILED DESCRIPTION

System-on-Chip (SoC) technology has become increasingly prevalent in modern electronics, revolutionizing the way electronic devices are designed and manufactured. SoCs are integrated circuits that combine multiple electronic components and subsystems onto a single chip. They enable many modern electronic devices, from smartphones and tablets to IoT devices, automotive systems, and more. SoCs have gained widespread adoption because of their ability to pack essential functionality into a compact, power-efficient, and cost-effective form factor. The automotive industry heavily relies on SoCs for advanced driver assistance systems (ADAS), infotainment systems, engine control units, and more. These chips are crucial for enhancing vehicle safety, efficiency, and user experience. Moreover, modern SoCs are incredibly complex due to the integration of diverse components. They often feature multiple CPU cores (e.g., ARM Cortex), GPUs, DSPs, memory, I/O interfaces, and specialized accelerators for tasks like AI and machine learning. Complexity arises from optimizing these components for performance, power efficiency, and system reliability.

Network on Chip (NoC) is a communication architecture that has gained importance in modern system-on-chip (SoC) designs. It provides a structured way for different components within an SoC to communicate efficiently. NoCs serve as the communication backbone within an SoC, connecting various function elements such as CPUs, GPUs, memory controllers, accelerators, peripherals, and so on. This facilitates data exchange and coordination among these components. The NoCs can include router elements that are responsible for routing data packets from source to destination. Router elements can have input ports, output ports, and routing logic to determine the path that packets should take. Links are the physical connections between routers. They can be point-to-point or multi-drop connections and may have varying bandwidths, latencies, and power characteristics. Links are used to transmit data packets between router elements.

Various automotive subsystems can utilize one or more SoCs and NoCs. One such subsystem is the engine control unit (ECU). The ECU is the main processor of the engine system, managing fuel injection, ignition timing, and other engine functions for optimal performance and emissions control. Another automotive subsystem can include the Transmission Control Module (TCM). The TCM controls automatic transmission operation, including gear shifting, torque converter lockup, and more. Another automotive subsystem can include the Anti-lock Braking System (ABS). The ABS computer monitors wheel speed sensors and adjusts brake pressure to prevent wheel lockup during hard braking. Another automotive subsystem can include the Supplemental Restraint System (SRS). The SRS manages airbag deployment and safety systems, determining when and how airbags should inflate in a collision. Another automotive subsystem can include the Electronic Stability Control (ESC) or Vehicle Stability Control (VSC). ESC/VSC systems use sensors to monitor vehicle stability and intervene by selectively braking individual wheels or adjusting engine power to prevent skidding or loss of control. Another automotive subsystem can include the Traction Control System (TCS). The TCS uses wheel-speed sensors to prevent wheel spin during acceleration by reducing engine power or applying brakes to specific wheels. Another automotive subsystem can include the Body Control Module (BCM). The BCM oversees various body-related functions, including lighting, power windows, door locks, and more. Another automotive subsystem can include the climate control system. The climate control system uses various sensors to monitor cabin temperature and adjust heating, ventilation, and air conditioning (HVAC) settings accordingly. Another automotive subsystem can include the infotainment and navigation system: The infotainment system includes a central computer that manages audio, video, navigation, and connectivity features, including GPS, smartphone integration, and more. Another automotive subsystem can include the Advanced Driver Assistance Systems (ADAS). The ADAS systems use various sensors (e.g., cameras, radar, lidar, and the like) and computer processing to provide features such as adaptive cruise control, lane-keeping assistance, and automated emergency braking. Another automotive subsystem can include the Tire Pressure Monitoring System (TPMS). The TPMS uses sensors to monitor tire pressure and alert the driver to low tire pressure, enhancing safety and fuel efficiency. Another automotive subsystem can include an Electric Vehicle (EV) Control Systems. In electric and hybrid vehicles, sophisticated control systems manage the electric motor, battery charging and discharging, and regenerative braking.

The aforementioned automotive subsystems, as well as other automotive subsystems, may utilize one or more bus systems to communicate with other components and/or subsystems. The bus systems can include a PCI Express (PCIe) bus, Compute Express Link (CXL), Controller Area Network (CAN) bus, and/or other bus types. PCI Express (PCIe) is a high-speed computer expansion bus standard used for connecting various internal components of a computer system, primarily for the purpose of data communication. PCIe is commonly used for connecting graphics cards, storage devices, network cards, and a wide variety of other peripherals to a processor via a printed circuit board (PCB) assembly. PCIe offers significantly higher data transfer rates compared to traditional PCI. It achieves the higher data transfer rates by using multiple lanes (data paths) that can be aggregated together to increase bandwidth. Each lane can carry data independently, and the total bandwidth of the bus is determined by the number of lanes used. PCIe slots come in different sizes that determine the number of lanes available for data transfer. Common sizes include ×1, ×4, ×8, and ×16, where “×” represents the number of lanes. Larger slots (×8 and ×16) provide higher bandwidth and are often used for high-performance components like graphics cards. PCIe supports full-duplex communication, which means data can be sent and received simultaneously, enhancing overall data throughput. In some cases, PCIe devices and slots support hot swapping, allowing components to be added or removed from a system without shutting it down. This can be especially useful for components like external storage devices and network cards. Unlike a shared bus architecture, with PCIe, each PCIe device is connected directly through a point-to-point link. Thus, PCIe reduces contention for the bus and improves performance. PCIe has become a fundamental part of modern computer architecture, especially in systems that require high-speed data communication between components. The capability of PCIe to provide fast and efficient data transfer makes it well suited for various applications, including automotive applications.

Another interconnect solution that can be used is Compute Express Link (CXL). CXL builds upon the physical and electrical interfaces of PCIe with protocols that establish coherency, simplify the software stack, and maintain compatibility with existing standards. As with PCIe, CXL offers high-speed data transfer rates to meet the demands of data-centric workloads. It achieves this through multiple lanes that can be aggregated to provide higher bandwidth. One of the unique features of CXL is memory coherency, which allows multiple devices (such as processors, GPUs, and accelerators) to share a consistent view of memory. This enables more efficient data sharing and reduces the complexity of data management. Moreover, CXL provides cache coherency, ensuring that all devices accessing shared memory have an up-to-date view of the data. The cache coherency can be implemented by a variety of protocols, such as MESI (Modified, Exclusive, Shared, Invalid) or MOESI (Modified, Owner, Exclusive, Shared, Invalid).

The Controller Area Network (CAN) bus is a critical communication network used extensively in modern vehicles for connecting and coordinating various electronic control units (ECUs) and systems. The CAN bus is known for its high reliability and robustness. It was originally developed for use in the automotive industry, where it needs to operate in harsh environments with electrical noise and temperature extremes. In a vehicle, the CAN bus can be used in a multi-master bus topology, meaning that multiple ECUs can communicate simultaneously. This allows for real-time data sharing and coordination among various systems, including the engine control unit (ECU), transmission control unit (TCU), anti-lock braking system (ABS), SRS (airbag system), and more. Information is transmitted on the CAN bus in the form of messages. Each message includes an identifier (ID) and the data payload. Messages can be broadcast or targeted to specific ECUs based on their unique IDs. CAN bus supports different data rates, with common rates including 125 Kbps, 250 Kbps, 500 Kbps, and 1 Mbps. The CAN bus is well suited for real-time applications in vehicles, allowing for rapid data transmission and fast response times, making the CAN bus well suited for systems like engine control and ABS.

Disclosed embodiments promote effective BIST execution in various applications, including embedded systems, such as those found in vehicles, medical equipment, avionics, and/or other systems of critical importance. The functional safety test environment (FUSATE) of disclosed embodiments can be periodically awakened by a timer to execute BIST test sequences for one or more subsystems, and to process the results of the tests. The processing of the results can include alerting a user, and/or sending results to a remote server for storage and/or further analysis.

Techniques for testing are disclosed. The testing can involve verifying that the device performs its intended functions correctly. Various input scenarios are applied to the device to ensure proper responses and outputs. A signal characterization test measures the device behavior under different voltage and frequency conditions. It assesses parameters such as power consumption, voltage levels, and signal integrity. A signal timing analysis evaluates device performance in terms of clock frequencies, propagation delays, and setup/hold times. Parametric tests assess the electrical parameters of the device, such as voltage, current, resistance, capacitance, and frequency. These tests can be used to confirm that the device operates within specified ranges. The aforementioned tests are just a few examples of the many types of tests that can be performed on devices. The tests can include heartbeat tests to check for activity in a given subsystem. A heartbeat test, also known as a heartbeat signal or heartbeat mechanism, is a technique used in computer systems to monitor the health or availability of a component, service, or system. The concept is analogous to the regular pulsing of a heartbeat in a living organism, which indicates that the organism is alive and functioning. In computer systems, a heartbeat test involves sending periodic signals or messages to check if a component or system is operating correctly. The testing can be performed by a functional safety test environment (FUSATE). In embodiments, if the FUSATE fails to receive a heartbeat signal within the expected timeframe, it interprets this as a potential problem. The FUSATE can trigger actions such as generating an alert, initiating a failover to a backup system, or taking corrective measures to restart the component that failed to provide the heartbeat.

Discussed throughout, packetized communication refers to a concept in networking that involves dividing large amounts of data into smaller packets for transmission over a network. This approach offers several advantages over traditional circuit-switched communication, such as more efficient use of network resources and the ability to handle diverse types of data. The networks in disclosed embodiments can include PCIe networks, CXL networks, CAN networks, and/or other networks now known or hereinafter developed. The networks can include various nodes, some of which may provide functionalities of routers and switches, to enable forwarding packets to their destinations based on the information in the packetized communication. The information in the packetized communication can include metadata such as a packet type, length of associated data, if applicable, address/routing information, message encoding, a completion status, and/or other pertinent information. The address/routing information can include, but is not limited to, a bus number, a device number, and/or a routing type. In one or more embodiments, the FUSATE utilizes packetized communication via one or more of the aforementioned bus systems, such as PCIe, CXL, and/or CAN networks.

Methods of testing are disclosed. An automotive subsystem is accessed. The automotive subsystem can be included in a motor vehicle. The automotive subsystem can include a system-on-a-chip (SoC) which can utilize a network-on-a-chip (NOC) for interconnections. The SoC can be coupled to a communications bus which can include a bus controller. The SoC can be coupled to a functional safety test environment (FUSATE). The FUSATE can be in a low power mode including one or more sleep modes or low functionality modes. The FUSATE can be awakened from the low power mode by a timer. The timer can awaken the FUSATE when the timer counts above a predetermined threshold. The threshold can be programmable. Alternatively, the counter can count down from a predetermined value. The FUSATE can send a test sequence to one or more logic components within the SoC. The sending can include a functionality check. The functionality check can target one or more logic components within the SoC. The FUSATE can receive a first response from the one or more logic components within the SoC. It can then record the first response that was received. The FUSATE can then reenter the low power mode. When reentering the low power mode, the timer can be reset.

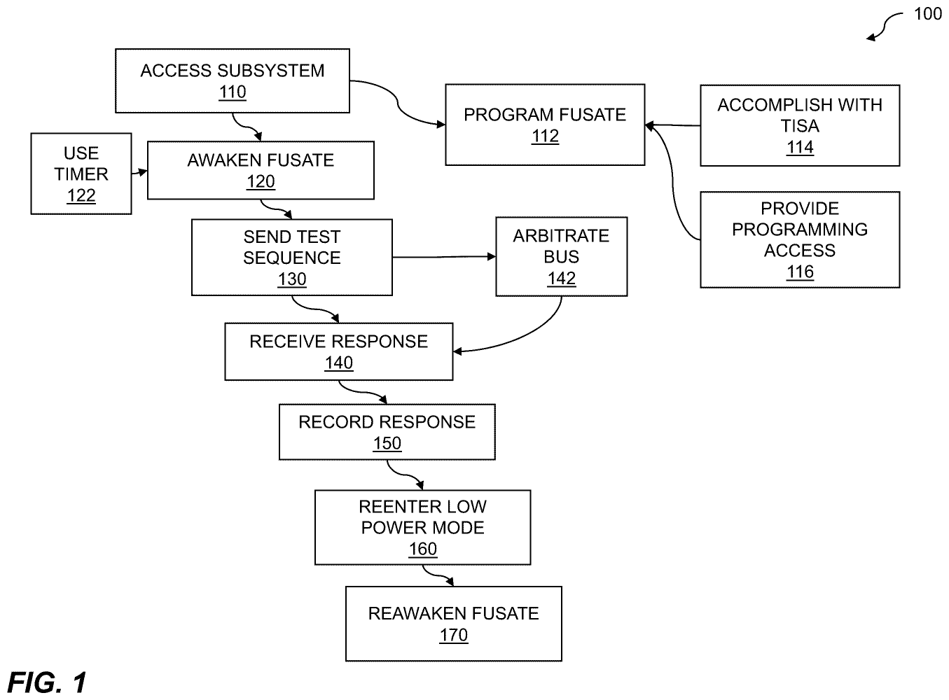

FIG. 1 is a flow diagram for functional safety BIST with system vitals. The system vitals can include parameters that have a defined operating range. As an example, a system vital can include a temperature of a SoC. The operating range for the SoC temperature may range from 20° C. to 90° C., after some initial uptime has elapsed. If, after the initial uptime has elapsed, the current SoC temperature is below 20° C., it could be indicative of a failure of part of the SoC. If the current SoC temperature is above 90° C., it could be indicative of a malfunction such as a short circuit or other error condition. The system vital can include a functional test. In disclosed embodiments, the FUSATE can include a dedicated computerized device that accesses a subsystem and performs tests, receives results, and can take one or more actions on the results.

The flow 100 starts with accessing a subsystem 110. The accessing can include accessing an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE). In embodiments, the NoC includes the FUSATE. In embodiments, the bus controller is a PCI-Express (PCIe) controller. In further embodiments, the communications bus is a PCIe bus. Other bus types are possible, along with an appropriate bus controller, including a Compute Express Link (CXL), Controller Area Network (CAN) bus, ethernet, universal serial bus (USB), and/or other bus types.

The flow 100 can include programming the FUSATE 112, wherein the programming is accomplished with a test instruction set architecture (TISA) 114. In one or more embodiments, the TISA 114 can include a plurality of opcodes. The opcodes can include opcodes for configuring and/or initializing a test environment, as well as opcodes for performing tests on a device-under-test (DUT). The opcodes can be compiled by a compiler. The compiler can include a general-purpose compiler, a hardware description-based compiler, a constraint-based compiler, a satisfiability-based compiler (SAT solver), and so on. The resulting compiled test can be executed by the FUSATE to execute one or more tests on the DUT. In one or more embodiments, the DUT can include an automotive subsystem. The automotive subsystem can include engine control systems, emissions control systems, steer-by-wire systems, climate control systems, transmission systems, infotainment systems, and so on.

The flow 100 can include providing programming access 116 through a test port of the FUSATE. The test port can include an ethernet port, USB port, serial port, and/or other suitable port type. The FUSATE can be programmed to periodically execute one or more self-tests such as BIST with system vitals. When used in a vehicular application, the FUSATE can monitor one or more subsystems of the vehicle to ensure proper operation. Disclosed embodiments can periodically transmit test results as telemetry data that can be analyzed by a remote server. In one or more embodiments, an application programing interface (API) can expose functions to pass data from one or more vehicles to the remote server. In this way, disclosed embodiments can provide BIST data for a fleet of vehicles.

The flow 100 includes awakening the FUSATE 120. The flow 100 can include using a timer 122 to awaken the FUSATE 120. Embodiments can include awakening, by a timer, the FUSATE from a low power mode. In embodiments, the timer awakens the FUSATE when it is at or above a first threshold. In embodiments, the first threshold is programmable. In embodiments, the first threshold has a value ranging from 1 millisecond to 100 milliseconds. In some embodiments, the first threshold has a value ranging from 1 second to 300 seconds. In one or more embodiments, the first threshold is 10 milliseconds. The timer can count up based on the value of the first threshold. In embodiments, the counter counts down from the threshold. In some embodiments, the timer is included in the FUSATE. In other embodiments, the timer is separate from the FUSATE. In response to the timer expiring, the FUSATE can be awakened.

With the FUSATE awakened, the flow 100 continues with sending, by the FUSATE, a test, to one or more logic components within the SOC, a test sequence 130, wherein the test sequence includes a functionality check of the one or more logic components. The test sequence can be programmed by a user, where the test sequence includes one or more instructions from within the TISA. The test sequence can test one or more logic components within the SoC which can be an automotive subsystem. In one or more embodiments, the test sequence can include a variety of individual tests. These tests can include signal integrity requirements for a transmitter and/or receiver, such as rise time, fall time, jitter, signal voltage levels, and so on. The tests can be used to confirm that the aforementioned parameters are within acceptable limits. The tests can include protocol tests, such as transaction layer packet tests, to check for proper packet generation, ordering, and flow control. The tests can further include packet error testing to evaluate how a device handles errors, such as CRC errors, flow control errors, and/or other error conditions. The tests can include link testing. Other tests can include, but are not limited to, base specification testing, power management testing, performance testing, and so on. In some embodiments, the test sequence targets a connectivity of the NoC. In other embodiments, the test sequence comprises a heartbeat test. A heartbeat test, also known as a heartbeat signal or heartbeat mechanism, is a technique used in computer systems to monitor the health or availability of a component, service, or system. The concept is analogous to the regular pulsing of a heartbeat in a living organism, which indicates that the organism is alive and functioning. In computer systems, a heartbeat test involves sending periodic signals or messages to check if a component or system is operating correctly.

The flow 100 further includes receiving, by the FUSATE, a first response 140 from the one or more logic components within the SOC. The first response can include a Boolean test result, such as a pass/fail indication, an enumerated test result that includes one of a plurality of possible discrete values, and/or one or more additional parameters. As described above, the response can be a result of sending a test to the one or more logic components within the SoC. The response can include a result of a signal integrity test, protocol test, flow control test, link test, functional test, and so on from one or more logic blocks within the SoC.

In embodiments, the FUSATE is external to the SoC, wherein the FUSATE is coupled to the bus controller and the communications bus. In this case, because the FUSATE is not within the NoC and cannot take advantage of NoC to SoC communication protocols, the FUSATE can communicate with the SoC over the communications bus. Thus, in embodiments, the receiving occurs over the communications bus. Transactions over the communication bus can include the BIST test data. Other functional communications can be sent over the communications bus. These can include transactions between automotive systems, logic blocks, systems controllers, and so on. Thus, in embodiments, a functional transaction can include a non-BIST transaction. In embodiments, the BIST test data is interleaved with functional transactions. As an example, a climate control BIST can periodically check comments of a climate control system, such as a fan, thermostat, and the like. In between BIST tests, functional transactions, such as caused by a user adjusting climate control settings of a vehicle, can occur. In embodiments, the first response includes a packetized communication. The packetized communication can occur over the communication bus.

When the FUSATE is external to the SoC, the flow 100 can include arbitrating 142, by the bus controller, between the test sequence and one or more functional transactions on the communications bus. The functional transactions can be part of normal operations of the automotive subsystem. The arbitrating can include inserting test sequences on the communications bus when there are no functional transactions. The arbitrating can include holding functional transactions to insert a test sequence. In embodiments, the holding is based on a priority of the functional transaction and/or a priority of the test sequence. For example, the arbitrating can include taking priority of communications into account. For example, while test signals are generally a lower priority than functional communications, a test sequence could be elevated in priority if the arbitrating has not been able to run a high priority test in a programmable time period. The time period can include milliseconds, seconds, and so on. In embodiments, when the FUSATE is external to the SoC, the FUSATE comprises an application specific integrated circuit (ASIC). In other embodiments, the FUSATE comprises a field programmable gate array (FPGA). In additional embodiments, when the FUSATE is external to the SoC, the receiving occurs over a test response bus. The test response bus can provide communications between the SoC and the FUSATE. The test response bus can include packetized communications such as PCI-Express or other communication protocols.

The flow 100 further includes recording the response 150. Embodiments can include recording, by the FUSATE, the first response that was received. The recording can be accomplished within the FUSATE. In embodiments, the FUSATE includes one or more caches to internally store the first response. The FUSATE can include DRAM, or SRAM, SDRAM, or other storage technologies to record the first response. In embodiments, the recording includes an identification number for the automotive subsystem. In embodiments, the recording includes an identification of the one or more logic components. In embodiments, the recording includes a motor vehicle identification.

The flow 100 further includes reentering low power mode 160. Entering low power mode for the FUSATE can include lowering the clock speed of one or more processors in order to reduce power consumption. In some embodiments, one or more processors within the FUSATE are multi-core processors. In embodiments with multi-core processors, reentering the low power mode can include core deactivation, as fewer active cores can consume less power. In vehicular applications, particularly with hybrid and/or electric vehicles, saving power takes on increased importance as compared with conventional internal combustion engine (ICE) powered vehicles. Reentering the low power mode can include disabling wireless communication modules such as Wi-Fi, Bluetooth, and/or cellular communication interfaces. Other low power techniques may be used instead of, or in addition to, the aforementioned low power mode entry operations in one or more embodiments.

Embodiments can include reentering, by the FUSATE, the low power mode 160, wherein the reentering includes resetting the timer. The flow 100 can include reawakening the FUSATE 170 from the lower power mode, wherein the reawakening is based on the resetting the timer. The reawakening can cause the FUSATE to perform additional BIST sequences. The reawakening of the FUSATE can include reactivation of one or more elements that were previously put in a low power mode. This can include reactivation of one or more cores of a multi-core processor, enabling wireless radios (e.g., Wi-Fi, Bluetooth, cellular), and communication interfaces, increasing processor clock speeds, and so on. In embodiments, after the FUSATE is reawakened, the receiving includes a second response.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

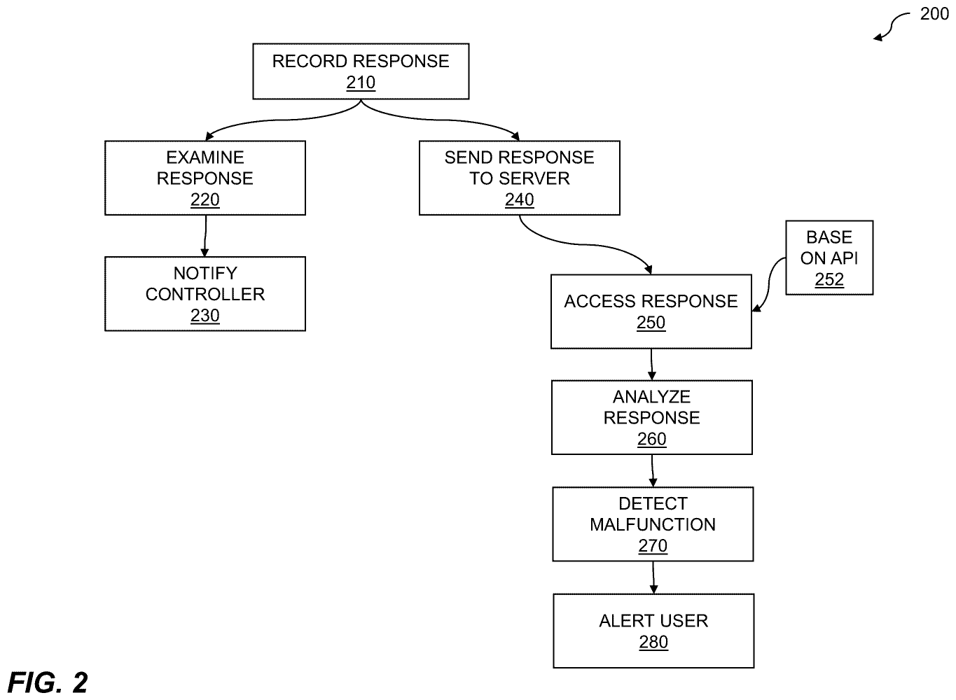

FIG. 2 is a flow diagram for recording a response. The flow 200 starts with recording a response 210. The response can include one or more bytes of data. The data can include pass/fail test results, heartbeat messages, and/or one or more parameters. As described above, the data can be in response to a test sequence that was sent by the FUSATE and can comprise the first response that was received by the FUSATE. Thus, in embodiments, the flow can include recording, by the FUSATE, the first response that was received. The flow can include examining the response 220. Embodiments can include examining the first response, wherein the examining detects a malfunction of the automotive subsystem. The responses can include voltages, currents, temperatures, number of process restarts, number of device reboots, available memory, and/or other parameters. The analysis can include determining if the parameters that are received are within a specified operating range. In one or more embodiments, parameters that are outside of their corresponding specified operating range can generate warnings, errors, and/or cause mitigation actions to be performed. The flow 200 can further include notifying a controller 230. Thus, embodiments can include notifying an automotive controller of the malfunction. The automotive controller can include an embedded computer device in one or more embodiments. The notifying can trigger functions or actions by the automotive subsystem. In embodiments, the automotive subsystem communicates an error to a user. In a usage example, the FUSATE can detect an error in the braking system. The notifying can cause the automotive subsystem to highlight a message to a driver of a motor vehicle to pull over as soon as safely possible. In embodiments, the notifying can cause the motor vehicle to pull over on its own when equipped with self-driving technology.

As an example of parameter range checking, the FUSATE can perform BIST sequences on a Steer-by-wire (SBW) system. SBW is an advanced automotive technology that replaces the traditional mechanical linkages between the steering wheel and the wheels with electronic controls and sensors. In a steer-by-wire system, the driver's input from the steering wheel is no longer directly connected to the physical movement of the vehicle's wheels. Instead, electronic signals are sent to actuators, motors, or electronic controllers that control the steering of the vehicle. An SBW system provides advantages such as eliminating mechanical linkages, thereby allowing for more flexible and innovative vehicle designs. An SBW system can simplify the implementation of autonomous or semi-autonomous vehicles without a traditional steering wheel. Moreover, an SBW system facilitates removing the mechanical components associated with traditional steering systems, which can reduce the overall weight of the vehicle, contributing to improved fuel efficiency. Along with the advantages of an SBW system, there is a need to ensure the reliability and redundancy of electronic and processor components within the SBW to avoid potential safety hazards in case of system failures. The FUSATE of disclosed embodiments can be used to provide additional safeguards for the SBW system and/or other important automotive subsystems. For example, if the FUSATE detects continuously increasing memory usage of an automotive subsystem, such as the SBW system, the FUSATE can provide a notification to an automotive controller once the increasing memory usage trend is identified. This can be indicative of a memory leak. In some cases, such a memory leak may not be detected in formal quality assurance (QA) tests, but occurs in real-world conditions. With the FUSATE of disclosed embodiments, important parameters of key automotive subsystems can be monitored during real-world usage, helping to improve the quality, safety, and efficiency of automobiles and/or other vehicles.

The flow 200 can include sending 240, to a remote server, the first response. In embodiments, the sending is based on a number of responses recorded, wherein the number is above a second threshold. The second threshold can have a value different than the first threshold and can be larger. The larger second threshold can serve to alleviate network congestion during the sending. The second threshold can include any amount of time. In some embodiments, the second threshold has a value ranging from 100 milliseconds to 1 second. In other embodiments, the second threshold can range from 1 second to 300 seconds. Using the second threshold can reduce the interval in which data is sent to the remote server, thus reducing traffic. The FUSATE can use one or more buffers to store data, such as test data and test response data, before it is sent to the remote server.

The flow 200 can include accessing the response 250. Embodiments can include accessing, by a software program, the first response on the remote server, wherein the accessing is based on an application programming interface (API) 252. The remote server can be a server located in another vehicle, in a building, in a cloud-implemented virtual server, and so on. The software program can run on a separate compute device. The APIs can include HTTP/HTTPS (RESTful APIs). In one or more embodiments, the Hypertext Transfer Protocol (HTTP) and/or the secure variant, HTTPS, are used for sending data collected by the FUSATE to a remote server. Embodiments can use RESTful APIs (Representational State Transfer) that include methods such as GET, POST, PUT, and DELETE to interact with server endpoints and send data in JSON (JavaScript Object Notation) or XML (extensible Markup Language) formats. One or more embodiments may use XML-RPC and/or JSON-RPC. These are remote procedure call (RPC) protocols that use XML or JSON as the message format for invoking methods or functions on, and/or providing responses to, the remote server. Some embodiments may utilize SOAP (Simple Object Access Protocol). In one or more embodiments, the FUSATE utilizes the SOAP protocol for exchanging structured information with, and/or providing responses to, the remote server.

The flow 200 can include analyzing the response 260. The response can be analyzed by the server. The analysis can be performed in near-real time. Alternatively, the analysis can be performed in a batch mode. As an example, one or more vehicles of a fleet can upload FUSATE BIST results to the remote server periodically during operation of the vehicles. Then, at a scheduled time, e.g., 2:00 a.m. daily, the remote server can analyze the response 260. The analysis can include analysis of parameters such as voltages, currents, temperatures, pressures, fluid levels, number of process restarts, number of device reboots, available memory, and/or other parameters. The analysis can include determining if the parameters that are received are within a specified operating range. The flow 200 can include detecting a malfunction 270. Embodiments can include analyzing the first response, wherein the analyzing detects a malfunction of the automotive subsystem. In one or more embodiments, parameters that are outside of their corresponding specified operating range can generate warnings, errors, and/or cause mitigation actions to be performed. Additionally, the analysis can include comparing the parameters from a specific vehicle to a group of vehicles. As an example, an oil pressure value from a specific vehicle can be compared with oil pressure values from a fleet of similar vehicles, to determine if the oil pressure value from the specific vehicle is unusual. Identifying outliers in a parameter of an automotive subsystem can help detect errors, anomalies, or important data points that deviate significantly from the majority of the data. Disclosed embodiments can use one or more of various statistical measures and techniques to identify outliers. In one or more embodiments, the statistical measures can include a Z-score. The Z-score measures how many standard deviations a data point is from the mean of the dataset. Data points with Z-scores significantly greater or smaller than a threshold can be indicative of a malfunction. In one or more embodiments, a Z-score of ±3 is used as a criterion to consider a data point as an outlier, which could be indicative of a potential malfunction. In one or more embodiments, the statistical measures can include DBSCAN (Density-Based Spatial Clustering of Applications with Noise). The DBSCAN is a clustering algorithm that can also be used to identify parameters of an automotive subsystem as outliers that are not part of any dense cluster. Other statistical measures can be used in addition to, or instead of, the aforementioned statistical measures, in some embodiments. In one or more embodiments, outliers are interpreted as malfunctions. As an example, an oil pressure reading that is more than 2 standard deviations outside a fleet average value for oil pressure can be interpreted as a malfunction. In one or more embodiments, parameters outside of a specified range are interpreted as malfunctions. As an example, a circuit voltage that exceeds 7 volts can be interpreted as a malfunction.

The flow 200 can include alerting a user 280 of the malfunction. The alerting can include indicating warnings, errors, and/or mitigation actions to the user. The user can be an operator of the vehicle. The alert can be provided to an in-vehicle user via an infotainment system within the vehicle. The user can include another stakeholder that is not in the vehicle. As an example, the user can be a fleet manager of a group of vehicles. The alert can include an email, text message, and/or other application message to an electronic device (e.g., smartphone) associated with the user. In one or more embodiments, the alert can be included in a feed, social media system, messaging system channel (such as a Slack® channel), website, and/or other technique for disseminating information pertaining to the malfunction.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

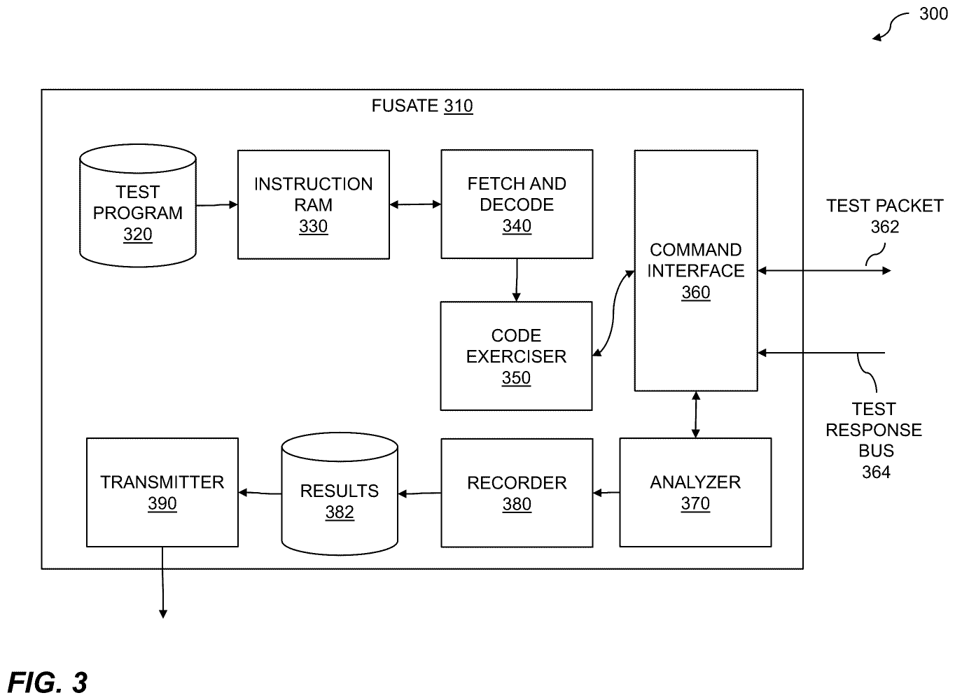

FIG. 3 is a block diagram for a FUSATE. In the block diagram 300, the FUSATE 310 can be included in a NoC within an SoC. The SoC can include the one or more logic components to be tested. In embodiments, the FUSATE can be external to the SoC wherein the FUSATE is coupled to the bus controller and the communications bus. The FUSATE can include a test program 320. The test program 320 can be based on a test instruction set architecture (TISA). The TISA can include a plurality of opcodes. The opcodes can include opcodes for configuring and/or initializing a test environment, as well as opcodes for performing tests on a device-under-test (DUT). The test program can be compiled. The compiled test program 320 can be loaded into instruction random-access memory (RAM) 330. The instruction RAM 330 can include dynamic random-access memory (DRAM). In one or more embodiments, the instruction RAM 330 is comprised of HBM (High Bandwidth Memory), DDR4 (Double Data Rate 4) RAM, DDR5 (Double Data Rate 5) RAM, or other suitable DRAM type. In some embodiments, the instruction RAM 330 can include static RAM (SRAM).

A fetch and decode (FAD) block 340 provides instructions from the instruction RAM 330 to the code exerciser 350. The FAD block 340 performs functions to enable execution of opcodes in the TISA. The FAD block 340 can include a fetch stage. The fetch stage is the first step in the instruction execution cycle. The primary function of the fetch is to retrieve the next instruction from memory. The FAD may utilize input based on a program counter (PC) or instruction pointer to determine the memory address of the next instruction to be fetched. In embodiments, the fetch operation involves reading the instruction from the specified memory location in the instruction RAM 330 and loading it into an instruction register within the code exerciser 350 in preparation for execution of the instruction. In embodiments, the code exerciser 350 can include one or more processors. The one or more processors can include ARM processors or other suitable processor types. In particular, ARM processors are well suited for running embedded Linux operating systems. In one or more embodiments, the FUSATE utilizes an embedded Linux operating system. In embodiments, a Linux-based compiler can generate tests that run on the FUSATE, including a basic heartbeat test. In embodiments, the compiler that creates the tests may be executed on an external computer, and the compiled tests can be downloaded to the FUSATE. The Linux operating system can include alpine Linux, PREEMPT-RT, Xenomai, and/or another suitable Linux operating system. In one or more embodiments, the FUSATE can include one or more processors, such as ARM processors, that are capable of operating an embedded Linux operating system.

The FAD block 340 may also include a decode stage. The decode stage can include examination of additional operands and/or arguments, address identification, and so on. The code exerciser can include a combination of hardware, software, and/or microcode for translating instructions into packetized communication. In embodiments, some opcodes within the TISA cause the code exerciser 350 to create a single targeted packetized communication to the DUT. In other embodiments, some opcodes within the TISA cause the code exerciser 350 to create multiple packetized communications, creating a hierarchical, flexible testing environment. Additional opcodes can be added to the TISA. The packetized communication is sent via command interface 360, via a test packet 362 to a DUT. In embodiments, when the FUSATE is included in the same SoC as the one or more logic components to be tested, the test packet can be sent via a NoC within the SoC. The DUT can include one or more components within an automotive subsystem, such as an antilock brake module, engine control module, and so on. In embodiments, the DUT may utilize an interconnect protocol such as PCIe, CXL, CAN, ethernet, or the like. In one or more embodiments, the FUSATE can include a test response bus 364 that receives responses from the DUT that include test results. Thus, in embodiments the FUSATE can include a dedicated test response bus for incoming test results. The test response bus 364 can be separate from the bus used to send test packet 362. In embodiments, when the FUSATE is included in the same SoC as the one or more logic components to be tested, the test response bus comprises the NoC within the SoC. In some embodiments, some test results may be provided to the FUSATE 310 via packetized communication. The DUT can respond to incoming packets with response packets that are sent, via the test response bus 364, to command interface 360. The command interface 360 can then provide the test results to analyzer 370.

The analyzer 370 may evaluate the data received from a DUT. In one or more embodiments, the analyzer 370 can utilize lookup tables to compare received results against data in the lookup tables. The lookup tables can include maximum acceptable values, minimum acceptable values, and/or normal values for one or more parameters. The parameters can include, but are not limited to, heartbeat response times, temperatures, voltages, currents, fluid levels, pressures, sound levels, mechanical dimensions (e.g., estimates of brake pad thickness based on braking system data), and so on. The analyzer can provide the test data and/or results to a recorder 380. The recorder 380 can include a non-volatile memory such as static RAM (SRAM), flash, magnetic storage, optical storage, and so on. The FUSATE 310 can extract results 382 can transmit them via transmitter 390. In one or more embodiments, the transmitter 390 includes a cellular transmitter, Wi-Fi transmitter, and/or a satellite uplink transmitter. Some embodiments may provide Dedicated Short-Range Communications (DSRC) and Cellular-V2X (C-V2X). Embodiments can include a transceiver that enables two-way communication, such that data, such as new and/or updated BIST sequences can be provided to a FUSATE.

In one or more embodiments, the transmitter 390 implements a modulation scheme such as Binary Phase Shift Keying (BPSK). BPSK is a simple modulation scheme where the phase of the carrier signal is shifted by 180 degrees to represent binary data (0 or 1). This makes it robust in noisy environments. Other embodiments may utilize Quadrature Phase Shift Keying (QPSK). QPSK extends BPSK by using four phase shifts to represent two bits of data per symbol, providing a higher data rate than BPSK while maintaining good noise tolerance. This can enable uplink of extended FUSATE data. In one or more embodiments, the amount of data uploaded can be based on a connection type, available bandwidth, geographic location, and/or other criteria. In some embodiments, the FUSATE creates a minimal uplink dataset and an extended uplink dataset. In embodiments, the minimal uplink dataset includes information pertaining to errors and/or failed BIST tests, while the extended uplink dataset can include additional parameters, enabling long-term evaluation of one or more automotive subsystems. In embodiments, when the available bandwidth is below a predetermined threshold, the FUSATE 310 only transmits the minimal uplink dataset. Similarly, when the available bandwidth is at or above the predetermined threshold, the FUSATE transmits both the minimal dataset and the extended dataset. In this way, communication bandwidth is optimized based on current conditions. In embodiments, the FUSATE comprises an ASIC. An ASIC, or application-specific integrated circuit, is a custom-designed integrated circuit (IC) chip that is created for a specific application or task, rather than for general-purpose computing. ASICs in disclosed embodiments can enable FUSATE functionality with high efficiency and performance, tailored to the needs of a specific application. In some embodiments, the FUSATE comprises an FPGA. An FPGA, or Field-Programmable Gate Array, is a type of integrated circuit (IC) that can be programmed and configured by the user or designer after manufacturing. FPGAs offer re-programmability and flexibility, making them a versatile tool in electronics and digital design.

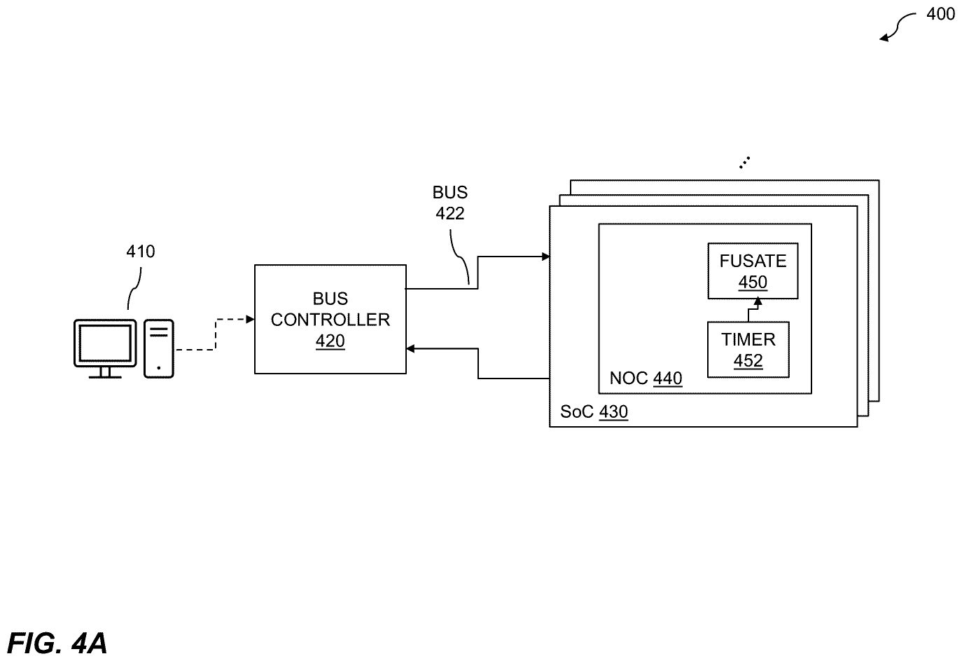

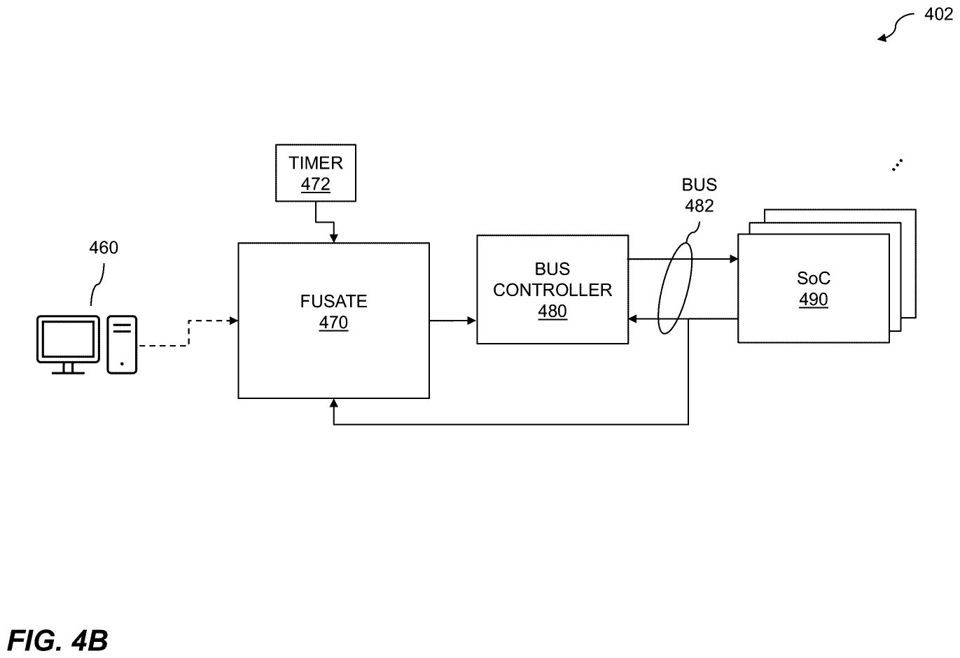

FIG. 4A is a first block diagram for functional safety BIST with system vitals. In the block diagram 400, a FUSATE 450 is shown within a NoC of an SoC which can include one or more logic functions to test. A host computer 410 can provide BIST sequences, lookup tables, and/or other data to a FUSATE 450 via a bus controller 420. Various bus controllers can be used, PCIe, CXL, ethernet, USB, and so on. The host computer 410 can include a desktop or laptop computer. The host computer 410 can include one or more applications executing thereon, such as compilers, linkers, assemblers, and/or other programs for the purposes of assembling a sequence of opcodes from a TISA into a test program. The host computer can interface with a bus controller that is coupled to a bus 422. In embodiments, the bus can utilize a variety of configurations. For example, PCIe utilizes multiple lanes (data paths) that can be aggregated together to increase bandwidth. Each lane can carry data independently, and the total bandwidth of the bus is determined by the number of lanes used. PCIe slots come in different sizes that determine the number of lanes available for data transfer. Configurations can include ×1, ×4, ×8, and ×16, where “×” represents the number of lanes. Larger slots (×8 and ×16) provide higher bandwidth and can be used for high-performance components that generate large amounts of data. PCIe supports full-duplex communication, which means data can be sent and received simultaneously, enhancing overall data throughput. In some cases, PCIe devices and slots support hot swapping, allowing components to be added or removed from a system without shutting it down. This can be especially useful for components like external storage devices and network cards. Unlike a shared bus architecture, with PCIe, each PCIe device is connected directly through a point-to-point link. Thus, PCIe reduces contention for the bus and improves performance. PCIe has become a fundamental part of modern computer architecture, especially in systems that require high-speed data communication between components. Its ability to provide fast and efficient data transfer makes it crucial for various applications, including gaming, content creation, scientific computing, and data storage solutions.

One or more SoCs 430 are coupled to the bus. In embodiments, the bus controller is communicatively coupled to one or more SoCs via bus 422. The SoCs can include a NoC 440. The FUSATE 450 is included within the NOC 440. The host computer 410 can communicate with the FUSATE 450 via the bus interface via the SoC and NoC interfaces. The communication an include loading a test sequence or BIST. The FUSATE 450 can be loaded via a wired or wireless interface. The FUSATE 450 may interface with a timer 452. In some embodiments, the timer 452 is external to the FUSATE 450 yet within the NoC 440, as illustrated in FIG. 4A. In some embodiments, the timer 452 is internal to the FUSATE 450. The SoCs 430 can include integrated circuits that support an automotive subsystem. The automotive subsystem can include an antilock braking subsystem, LIDAR control subsystem, steer-by-wire subsystem, navigation subsystem, battery charging subsystem, emissions control subsystem, and so on.

The FUSATE 450 can be configured to execute one or more BIST sequences. The sequences can be performed periodically based on the operation of timer 452. In one or more embodiments, the timer 452 sends an event message to the FUSATE 450 upon expiry of the timer 452. The event message can include a category. The category can include an automotive subsystem code (ASC). Each ASC can be associated with a different automotive subsystem. Each automotive subsystem can be within the same SoC as the FUSATE. In embodiments, a timer event message can include a list of automotive subsystems to test. The event message can include a test list. The test list can include one or more BIST sequences to be executed upon timer expiry. In one or more embodiments, an empty test list can indicate to the FUSATE 450 to execute all available tests. With these embodiments, the timer 452 can schedule various tests for various automotive subsystems within the SoC at different time intervals. The automotive systems can comprise one or more logic components. As an example, a safety critical system such as a steer-by-wire system may be tested every 200 milliseconds, while a less critical system such as a climate control system may be tested every 10 minutes. The tests can check system vitals. The system vitals can include one or more critical parameters. The critical parameters can include voltages, temperatures, currents, pressures, fluid levels, airflow measurements, heartbeat reply times, memory usage levels, processor utilization, memory fragmentation levels, and so on. In one or more embodiments, the timer 452 can be preprogrammed with a testing schedule for each automotive subsystem. In this way, a flexible functional safety BIST with system vitals can be achieved.

FIG. 4B is a second block diagram for functional safety BIST with system vitals. In the block diagram 402, a FUSATE 470 is shown external to one or more SoCs 490 which can include one or more logic functions to test. A host computer 460 can provide BIST sequences, lookup tables, and/or other data to the FUSATE 470. The host computer 460 can include a desktop or laptop computer. The host computer 460 can include one or more applications executing thereon, such as compilers, linkers, assemblers, and/or other programs for the purposes of assembling a sequence of opcodes from a TISA into a test program that can be loaded onto FUSATE 470 via a wired or wireless interface. The FUSATE 470 can interface with a timer 472. In some embodiments, the timer 472 is external to the FUSATE, as illustrated in FIG. 4B. In some embodiments, the timer 472 is internal to the FUSATE 470. In the figure, the FUSATE 470 is shown communicatively coupled to a bus controller 480. The bus controller can comprise a PCIe controller, but other controllers can be used, such as CXL, ethernet, USB, and so on. In embodiments, the bus controller 480 is communicatively coupled to one or more SoCs 490, via bus 482. The SoCs can include integrated circuits that support an automotive subsystem. The automotive subsystem can include an antilock braking subsystem, LIDAR control subsystem, steer-by-wire subsystem, navigation subsystem, battery charging subsystem, emissions control subsystem, and so on.

In embodiments, the bus can utilize a variety of configurations. For example, PCIe utilizes multiple lanes (data paths) that can be aggregated together to increase bandwidth. Each lane can carry data independently, and the total bandwidth of the bus is determined by the number of lanes used. PCIe slots come in different sizes that determine the number of lanes available for data transfer. Configurations can include ×1, ×4, ×8, and ×16, where “×” represents the number of lanes. Larger slots (×8 and ×16) provide higher bandwidth and can be used for high-performance components that generate large amounts of data. PCIe supports full-duplex communication, which means data can be sent and received simultaneously, enhancing overall data throughput. In some cases, PCIe devices and slots support hot swapping, allowing components to be added or removed from a system without shutting it down. This can be especially useful for components like external storage devices and network cards. Unlike a shared bus architecture, with PCIe, each PCIe device is connected directly through a point-to-point link. Thus, PCIe reduces contention for the bus and improves performance. PCIe has become a fundamental part of modern computer architecture, especially in systems that require high-speed data communication between components. Its ability to provide fast and efficient data transfer makes it crucial for various applications, including gaming, content creation, scientific computing, and data storage solutions.

The FUSATE 470 can be configured to execute one or more BIST sequences. The sequences can be performed periodically based on the operation of timer 472. In one or more embodiments, the timer 472 sends an event message to the FUSATE 470 upon expiry of the timer 472. The event message can include a category. The category can include an automotive subsystem code (ASC). Each ASC can be associated with a different automotive subsystem. In embodiments, a timer event message can include a list of automotive subsystems to test. The event message can include a test list. The test list can include one or more BIST sequences to be executed upon timer expiry. In one or more embodiments, an empty test list can indicate to the FUSATE 470 to execute all available tests. With these embodiments, the timer 472 can schedule various tests for various automotive subsystems at different time intervals. As an example, a safety critical system such as a steer-by-wire system may be tested every 200 milliseconds, while a less critical system such as a climate control system may be tested every 10 minutes. The tests can check system vitals. The system vitals can include one or more critical parameters. The critical parameters can include voltages, temperatures, currents, pressures, fluid levels, airflow measurements, heartbeat reply times, memory usage levels, processor utilization, memory fragmentation levels, and so on. In one or more embodiments, the timer 472 can be preprogrammed with a testing schedule for each automotive subsystem. In this way, a flexible functional safety BIST with system vitals can be achieved.

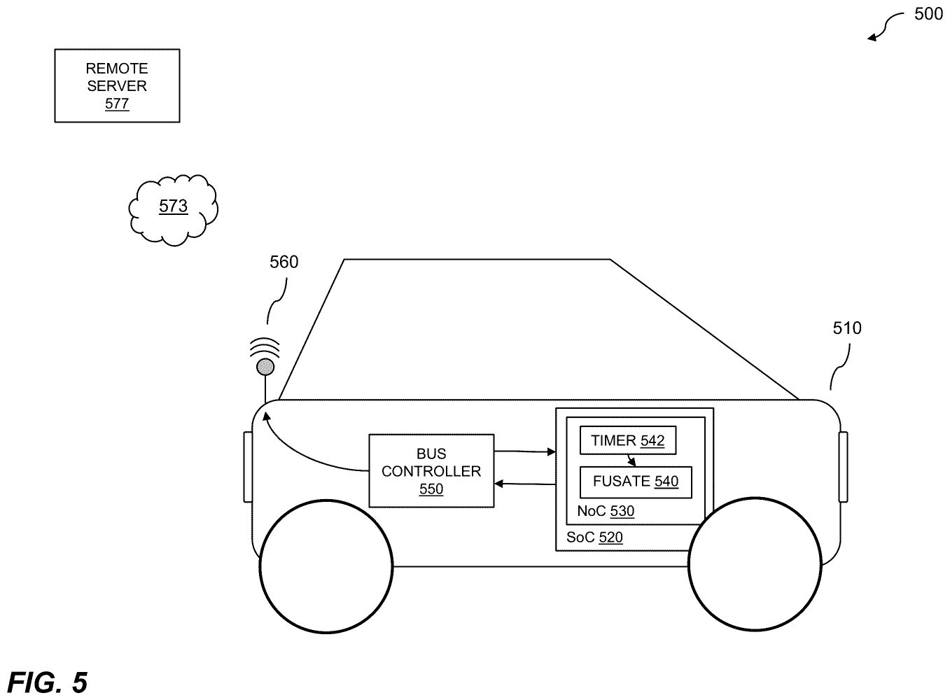

FIG. 5 is an example of an automotive functional test system. In the example 500, vehicle 510 includes an SoC integrated circuit, indicated at 520. The SoC can be associated with a variety of automotive subsystems. In practice, the vehicle 510 can include a plurality of SoCs controlling a plurality of automotive functions. The SoC 520 can include a NoC 530 which can provide a communication interface for the components of the SoC. The NoC 530 can include the FUSATE 540 which can be coupled to the SoC via the NoC communication interface. The vehicle 510 can include a timer 542 for controlling the periodicity and/or frequency at which BIST sequences are executed by the FUSATE 540. In embodiments, timer 542 may be similar to timer 452 previously described. The SoC can be coupled to a bus controller 550. The bus controller 550 can communicate with the SoC over an appropriate bus. For example, a PCIe controller can communicate over a PCIe bus. FUSATE 540 can be similar to FUSATE 310, previously described and shown in FIG. 3. In one or more embodiments, the bus can be used to provide high-speed connectivity that can include over-the-air (OTA) software updates for the FUSATE and/or other peripherals. The results and/or additional retrieved data can be uploaded to a remote server 577 via transceiver 560 through network 573. In embodiments, the sending is based on a number of responses recorded, wherein the number is above a second threshold. The second threshold can have a larger value than the first threshold. The larger second threshold can serve to alleviate network congestion. In some embodiments, the second threshold has a value ranging from 60 seconds to 300 seconds. In this way, data is sent to the remote server 577 at a reduced interval compared to data collection within the vehicle 510, thereby conserving valuable network resources such as cellular network resources that can be limited and/or incur costs when used.

In embodiments, the transceiver can utilize one or more standards, including, but not limited to, IEEE 802.11p, ETSI ITS-G5, and 3GPP. Network 573 can include a wide area network, local area network, cellular network, and/or the Internet. In one or more embodiments, the FUSATE can connect to an OBD-II port of a vehicle. The On-Board Diagnostics II (OBD-II) port is a standardized diagnostic interface found in most modern vehicles, and it enables performing of various tasks related to monitoring and troubleshooting vehicle performance and emissions. In embodiments, the FUSATE can obtain diagnostic trouble codes (DTCs) stored in an onboard computer of a vehicle. These codes provide information about specific issues or malfunctions in various vehicle systems, such as the engine, transmission, brakes, and emissions control, to name a few.

The vehicle 510 can include an automobile, as indicated in FIG. 5. However, disclosed embodiments are not limited to automobiles. The FUSATE of disclosed embodiments can be utilized in other vehicles, including, but not limited to, trucks, trains, motorcycles, scooters, electric bicycles, airplanes, drones, helicopters, spacecraft, satellites, surface ships, submarines, and so on. Moreover, the FUSATE of disclosed embodiments can be used in a variety of non-vehicle applications, such as medical equipment, process control systems, power generation systems, building elevator systems, fire suppression systems, and/or other systems that can impact safety. The bus controller can be a PCIe bus controller, but other buses and/or communication ports may be used, such as a CAN bus, ethernet network, OBD-II port, and so on.

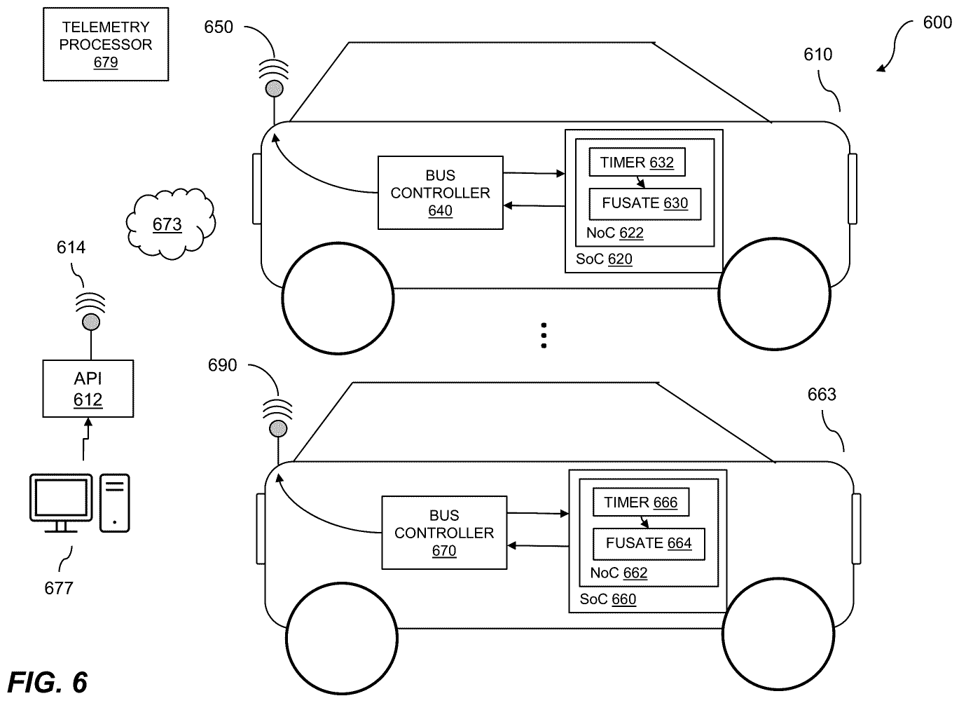

FIG. 6 is a block diagram for sending functional safety information. Block diagram 600 depicts multiple vehicles, indicated at 610 and 663. While two vehicles are shown in FIG. 6, in embodiments, more than two vehicles can be present. The multiple vehicles can be part of a fleet, vehicles of a similar category, vehicles in a particular geographic region, and so on. Vehicle 610 includes an SoC integrated circuit, indicated at 620. The SoC can be associated with a variety of automotive subsystems and a variety of logic functions. In practice, a plurality of SoCs can be included in vehicle 610. The SoC can include a NoC 622, which can provide communications between components within the SoC 620. The NoC 622 can include a FUSATE 630. In embodiments, FUSATE 630 can be similar to FUSATE 310 previously described and shown in FIG. 3. The vehicle 610 can include a timer 632 for controlling the periodicity and/or frequency at which BIST sequences are executed by the FUSATE 630. In embodiments, timer 632 can be similar to timer 452 previously described. The timer 632 can be included in the NoC 622. The SoC 620 can communicate over a bus that is controlled by bus controller 640. The bus controller can be coupled to a transceiver 650. Results and/or additional retrieved data from the FUSATE operation can be uploaded to a remote server 677 via transceiver 650 through network 673.

Similarly, vehicle 663 includes an SoC integrated circuit 660. The SoC can be associated with a variety of automotive subsystems and a variety of logic functions. In practice, a plurality of SoCs can be included in vehicle 663. The SoC can include a NoC 662, which can provide communications between components within the SoC 660. The NoC 662 can include a FUSATE 664. FUSATE 664 can be similar to FUSATE 310 previously described and shown in FIG. 3. The vehicle 663 can include a timer 666 for controlling the periodicity and/or frequency at which BIST sequences are executed by the FUSATE. The timer 666 can be similar to timer 452, previously described. The timer 666 can be included in NoC 662. The SoC 660 can communicate over a bus that is controlled by bus controller 670. The bus controller can be coupled to a transceiver 690. Results and/or additional retrieved data from the FUSATE operation can be uploaded to a remote server 677 via transceiver 690 through network 673.

In general, the components and networks shown in FIG. 6 may be similar to components previously described and shown in FIGS. 1-5. In one or more embodiments, the remote server 677 may send/receive results and/or additional data via API 612, from the vehicles 610 and 663 via communication interface 614. Communication interface 614 can include a wireless communication interface such as a Wi-Fi, Bluetooth, and/or cellular communication interface. Network 673 can include a wide area network, local area network, cellular network, and/or the Internet. In embodiments, the remote server 677 may send/receive data to/from telemetry processor 679. The telemetry processor 679 can include one or more computers that process large volumes of data from multiple vehicles. The telemetry processor 679 can include a software application such as Splunk® for processing, analyzing, and/or visualizing large amounts of data. This can enable identification of trends regarding BIST test results. As an example, if BIST tests are failing in a particular geographic region, a correlation can be made with that region to the failed tests. For example, if a supplemental restraint system (SRS) BIST is failing in a particular area that is prone to high levels of humidity, a correlation between high humidity levels and the failed BIST sequences can be used to further diagnose the issue and identify root causes.

In one or more embodiments, a FUSATE from one vehicle may communicate to a FUSATE from another vehicle, and/or an off-vehicle data storage device, utilizing Vehicle-to-Vehicle (V2V) and/or Vehicle-to-Everything (V2X) communication protocols and/or systems. In embodiments, the FUSATE may interface with an On-Board Unit (OBU) in a vehicle. The OBU can include components such as radios, antennas, and processing units. In one or more embodiments, the OBU can perform transmitting and receiving V2V and V2X messages, including information about vehicle position, speed, direction, and status information obtained from the FUSATE. In embodiments, the FUSATE utilizes a V2X system to connect to cloud-based services and data centers to provide information including test results from BIST sequences, as well as other telemetry data.

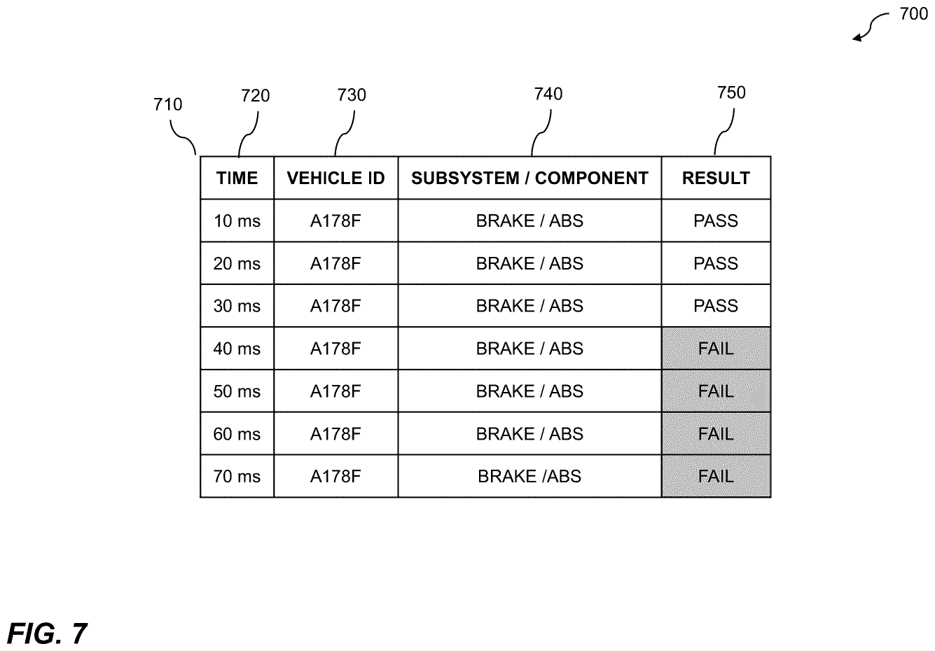

FIG. 7 is an example of accessing responses on a server. The example 700 shows a table 710, in which there is a column 720 for a time of the test. The time can be a free-running counter, a time of data, a GPS time, a Unix time, or another suitable time based on an epoch. The table 710 can include a vehicle identifier (ID) column 730. Column 730 can include an alphanumeric identifier. In one or more embodiments, the vehicle identifier can include a vehicle identification number (VIN) from a manufacturer. In other embodiments, the vehicle ID can include a randomly assigned number, a license plate alphanumeric identifier assigned by a state or other jurisdiction, and/or another suitable identifier. The table 710 can include a subsystem/component column 740. Column 740 can include a name and/or other identifier pertaining to a specific automotive subsystem. The table 710 can include a result column 750. In one or more embodiments, column 750 can include Boolean results, such as pass/fail. In other embodiments, column 750 can include ordinal values, including health scores and/or other metrics that are indicative of system vitals. In one or more embodiments, the FUSATE sends data similar to that depicted in table 710 to analyzers, remote servers, and/or telemetry processors, enabling a comprehensive assessment of the overall system health of a fleet of vehicles.

In one or more embodiments, the FUSATE may interface with one or more automotive subsystems to enable dynamic BIST scheduling. In some instances, periodically scheduled tests may be deferred or cancelled based on vehicle activity. The FUSATE can be configured to establish rules for BIST deferral. As an example, in embodiments, the FUSATE can be configured with a rule to not perform any tests when the vehicle is travelling over a given speed (e.g., 40 km/h). Other rules can include not performing a given test when the vehicle is moving, when the engine temperature is above a predetermined threshold, and/or other criteria. As an example, the FUSATE can be configured with a rule such that a traction control system (TCS) test is only performed when the vehicle is stationary. With the dynamic BIST scheduling of disclosed embodiments, BIST sequences to check system vitals can be executed without interfering with normal operations of the vehicle.

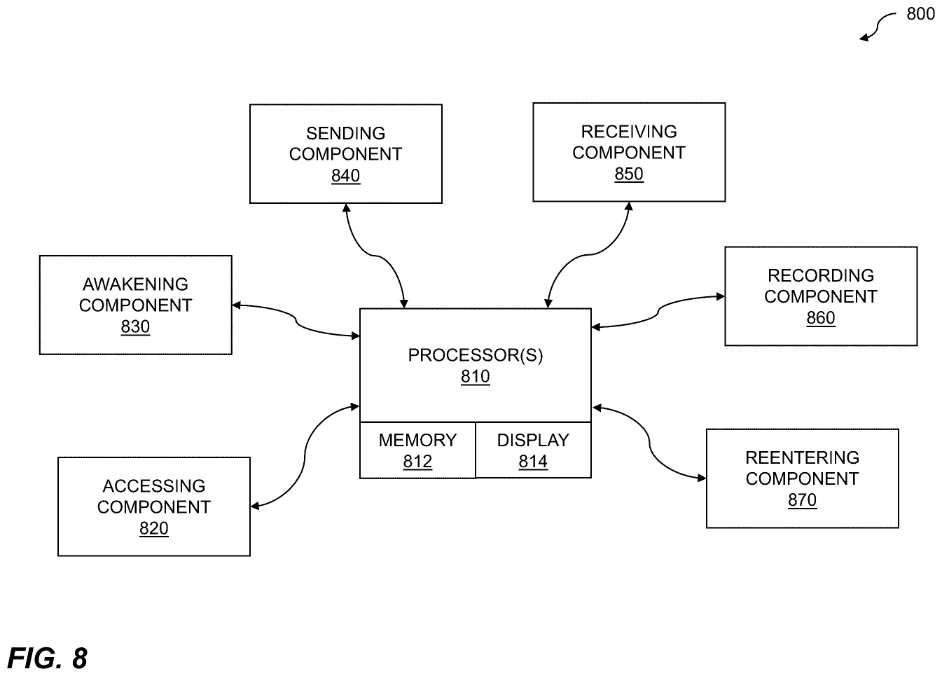

FIG. 8 is a system diagram for functional safety BIST with system vitals. The system 800 can include one or more processors 810, which are attached to a memory 812 which stores instructions. The system 800 can further include a display 814 coupled to the one or more processors 810 for displaying data; intermediate steps; directions; control words; creating sequences of opcodes, arguments, test scripts, compliance tests; and so on. In embodiments, one or more processors 810 are coupled to the memory 812, wherein the one or more processors, when executing the instructions which are stored, are configured to: access an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE); awaken, by a timer, the FUSATE from a low power mode; send, by the FUSATE, over the communications bus, a test sequence to the SoC, wherein the test sequence includes a functionality check of one or more logic components within the SoC, and wherein the sending includes arbitrating, by the bus controller, between the test sequence and one or more functional transactions on the communications bus; receive, by the FUSATE, a first response from the one or more logic components within the SoC; record, by the FUSATE, the first response that was received; and reenter, by the FUSATE, the low power mode, wherein the reentering includes resetting the timer.

The system 800 can include an accessing component 820. The accessing component 820 can include instructions and functions for accessing an automotive subsystem within a motor vehicle, wherein the automotive subsystem includes a system-on-a-chip (SoC), wherein the SoC includes a network-on-a-chip (NOC), wherein the SoC is coupled to a communications bus, wherein the communications bus includes a bus controller, and wherein the SoC is coupled to a functional safety test environment (FUSATE). The system 800 can include an awakening component 830. The awakening component 830 can include instructions and functions for awakening, by a timer, the FUSATE from a low power mode. The system 800 can include a sending component 840. The sending component 840 can include instructions and functions for sending, by the FUSATE, over the communications bus, a test sequence to the SoC, wherein the test sequence includes a functionality check of one or more logic components within the SoC, and wherein the sending includes arbitrating, by the bus controller, between the test sequence and one or more functional transactions on the communications bus.

The system 800 can include a receiving component 850. The receiving component 850 can include instructions and functions for receiving, by the FUSATE, a first response from the one or more logic components within the SoC. The system 800 can include a recording component 860. The recording component 860 can include instructions and functions for recording, by the FUSATE, the first response that was received. The system 800 can include a reentering component 870. The reentering component 870 can include instructions and functions for reentering, by the FUSATE, the low power mode, wherein the reentering includes resetting the timer.

As can now be appreciated, disclosed embodiments enable remote collection and transmission of data from vehicles. The features of disclosed embodiments, including the FUSATE, can provide numerous advantages for the management of a vehicle fleet. Disclosed embodiments can provide data to fleet management telemetry systems, and leverage various sensors and/or communication technologies to continuously monitor and transmit information about vehicle performance, location, and/or the status of various automotive subsystems. Moreover, disclosed embodiments can include monitoring vehicle health and/or sending alerts for maintenance needs, helping to prevent breakdowns and reduce downtime. Thus, disclosed embodiments can optimize maintenance schedules, saving on repair costs, while also improving overall vehicle safety.

The system 800 can include a computer program product embodied in a non-transitory computer readable medium for instruction execution, the computer program product comprising code which causes one or more processors to perform operations of: accessing an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE); awakening, by a timer, the FUSATE from a low power mode; sending, by the FUSATE, over the communications bus, a test sequence to the SoC, wherein the test sequence includes a functionality check of one or more logic components within the SoC, and wherein the sending includes arbitrating, by the bus controller, between the test sequence and one or more functional transactions on the communications bus; receiving, by the FUSATE, a first response from the one or more logic components within the SoC; recording, by the FUSATE, the first response that was received; and reentering, by the FUSATE, the low power mode, wherein the reentering includes resetting the timer.

The system 800 can include a computer system for instruction execution comprising: a memory which stores instructions; one or more processors attached to the memory wherein the one or more processors, when executing the instructions which are stored, are configured to: access an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE); awaken, by a timer, the FUSATE from a low power mode; send, by the FUSATE, over the communications bus, a test sequence to the SoC, wherein the test sequence includes a functionality check of one or more logic components within the SoC, and wherein the sending includes arbitrating, by the bus controller, between the test sequence and one or more functional transactions on the communications bus; receive, by the FUSATE, a first response from the one or more logic components within the SoC; record, by the FUSATE, the first response that was received; and reenter, by the FUSATE, the low power mode, wherein the reentering includes resetting the timer.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods (i.e., processor-implemented methods) may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for testing comprising:
accessing an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE);
awakening, by a timer, the FUSATE from a low power mode;
sending, by the FUSATE, to one or more logic components within the SOC, a test sequence, wherein the test sequence includes a functionality check of the one or more logic components;
receiving, by the FUSATE, a first response from the one or more logic components within the SoC;
recording, by the FUSATE, the first response that was received; and
reentering, by the FUSATE, the low power mode, wherein the reentering includes resetting the timer.

2. The method of claim 1 wherein the FUSATE is external to the SOC, wherein the FUSATE is coupled to the bus controller and the communications bus.

3. The method of claim 2 further comprising arbitrating, by the bus controller, between the test sequence and one or more functional transactions on the communications bus.

4. The method of claim 2 wherein the receiving occurs over the communications bus.

5. The method of claim 4 wherein the first response is interleaved, by the bus controller, with one or more functional transactions.

6. The method of claim 5 wherein the first response includes a packetized communication.

7. The method of claim 2 wherein the receiving occurs over a test response bus.

8. The method of claim 1 wherein the timer is at or above a first threshold.

9. The method of claim 8 wherein the first threshold is programmable.

10. The method of claim 1 wherein the recording includes sending, to a remote server, the first response.

11. The method of claim 10 wherein the sending is based on a number of responses recorded, wherein the number is above a second threshold.

12. The method of claim 10 further comprising accessing, by a software program, the first response on the remote server, wherein the accessing is based on an application programming interface (API).

13. The method of claim 12 further comprising analyzing the first response, wherein the analyzing detects a malfunction of the automotive subsystem.

14. The method of claim 13 further comprising alerting a user of the malfunction.

15. The method of claim 1 further comprising reawakening the FUSATE from the low power mode, wherein the reawakening is based on the resetting the timer.

16. The method of claim 15 wherein the receiving includes a second response.

17. The method of claim 1 further comprising examining, by the FUSATE, the first response that was recorded, wherein the examining detects a malfunction of the automotive subsystem.

18. The method of claim 17 further comprising notifying an automotive controller of the malfunction.

19. The method of claim 1 further comprising programming the FUSATE, wherein the programming is accomplished with a test instruction set architecture (TISA).

20. The method of claim 19 further comprising providing programming access through a test port of the FUSATE.

21. The method of claim 1 wherein the test sequence targets a connectivity of the NOC.

22. The method of claim 1 wherein the recording includes an identification number for the automotive subsystem.

23. The method of claim 1 wherein the recording includes an identification of the one or more logic components.

24. The method of claim 1 wherein the recording includes a motor vehicle identification.

25. A computer program product embodied in a non-transitory computer readable medium for testing, the computer program product comprising code which causes one or more processors to perform operations of:
accessing an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE);
awakening, by a timer, the FUSATE from a low power mode;
sending, by the FUSATE, to one or more logic components within the SOC, a test sequence, wherein the test sequence includes a functionality check of the one or more logic components;
receiving, by the FUSATE, a first response from the one or more logic components within the SoC;
recording, by the FUSATE, the first response that was received; and
reentering, by the FUSATE, the low power mode, wherein the reentering includes resetting the timer.

26. A computer system for testing comprising:
a memory which stores instructions;
one or more processors coupled to the memory wherein the one or more processors, when executing the instructions which are stored, are configured to:
access an automotive subsystem within a motor vehicle, wherein the automotive subsystem includes a system-on-a-chip (SoC), wherein the SoC includes a network-on-a-chip (NoC), wherein the SoC is coupled to a communications bus, wherein the communications bus includes a bus controller, and wherein the SoC is coupled to a functional safety test environment (FUSATE);
awaken, by a timer, the FUSATE from a low power mode, wherein the timer is at or above a first threshold;
send, by the FUSATE, to one or more logic components within the SOC, a test sequence, wherein the test sequence includes a functionality check of the one or more logic components;
receive, by the FUSATE, a first response from the one or more logic components within the SoC;
record, by the FUSATE, the first response that was received; and
reenter, by the FUSATE, the low power mode, wherein the reentering includes resetting the timer.
